(19) United States
(12) Patent Application Publication
(10) Pub. No.: US 2026/0265930 A1
(43) Pub. Date: Sep. 10, 2026

(54) POLYMER ELECTROLYTE MEMBRANE CELLS WITH CARBON-IONOMER MICROPOROUS LAYERS

(71) Applicant: GM GLOBAL TECHNOLOGY OPERATIONS LLC, Detroit, MI (US)

(72) Inventors: Venkata Raviteja YARLAGADDA, South Lyon, MI (US); Ellazar Villacampa NIANGAR, Lake Orion, MI (US); Swaminatha P. KUMARAGURU, Rochester Hills, MI (US)

(21) Appl. No.: 19/072,533

(22) Filed: Mar. 6, 2025

(51) Int. Cl. C25B 9/23; C25B 11/032; C25B 11/065; H01M 4/86; H01M 4/88; H01M 4/90; H01M 8/10; H01M 8/1004

(52) U.S. Cl. CPC C25B 9/23; C25B 11/032; C25B 11/065; H01M 4/8605; H01M 4/8807; H01M 4/9083; H01M 8/1004; H01M 2008/1095

(57) ABSTRACT

A membrane electrode assembly including a cathode electrode, an anode electrode, a polymer electrolyte membrane between the anode electrode and the cathode electrode, and a gas diffusion layer adjacent to the cathode electrode, the gas diffusion layer including at least one microporous layer having a carbon support and an ionomer. Other example membrane electrode assemblies, electrochemical electrolysis cells with membrane electrode assemblies, electrochemical fuel cells with membrane electrode assemblies, and methods for manufacturing membrane electrode assemblies are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to membrane electrode assemblies (MEAs) of polymer electrolyte membrane cells with carbon-ionomer microporous layers for electrolyzer or fuel cell applications, and more particular to carbon-ionomer microporous layers having no sintering requirement.

Polymer electrolyte membrane (PEM) cells may be used to produce electrical power or hydrogen. Each PEM cell includes a membrane electrode assembly (MEA) comprising of an anode electrode, a cathode electrode, a PEM therebetween, and a gas diffusion layer or porous transport layer adjacent to the cathode and anode electrodes. A PEM fuel cell is an electrochemical device that uses hydrogen as fuel and produces electrical power (electricity). A PEM electrolyzer is an electrochemical device that uses water as fuel and produces hydrogen when electricity is applied. In PEM fuel cell and electrolyzer applications, the gas diffusion layer comprises of a microporous layer and a macroporous layer, with the microporous layer coated on the macroporous layer. Conventionally, the microporous layer is made from a complex ink consisting of carbon powder and a mix of binders, surfactants, and thickeners (fluorinated polymers, cellulosic hydrocarbons, Triton X, BYK-345, etc.).

### SUMMARY

A membrane electrode assembly including a cathode electrode, an anode electrode, a polymer electrolyte membrane between the anode electrode and the cathode electrode, and a gas diffusion layer adjacent to the cathode electrode, the gas diffusion layer including at least one microporous layer having a carbon support and an ionomer.

In other features, the gas diffusion layer is a first gas diffusion layer, and the membrane electrode assembly further includes a second gas diffusion layer adjacent to the anode electrode.

In other features, the membrane electrode assembly further includes a porous transport layer adjacent to the anode electrode.

In other features, the ionomer of the microporous layer is a fluorinated ionomer.

In other features, the ionomer of the microporous layer is a non-fluorinated ionomer.

In other features, the carbon support includes carbon powder, carbon flake, carbon fiber, or a combination thereof.

In other features, the carbon powder has a particle size of 20 nm to 250 nm.

In other features, a ratio of the ionomer to the carbon support is 0.2 to 1.6.

In other features, the at least one microporous layer of the gas diffusion layer is a single layer.

In other features, the at least one microporous layer of the gas diffusion layer includes two or more layers.

In other features, the at least one microporous layer of the gas diffusion layer includes no hydrophobic binder.

In other features, an electrochemical electrolysis cell includes the membrane electrode assembly.

An electrochemical fuel cell includes a membrane electrode assembly having a cathode electrode, an anode electrode, a polymer electrolyte membrane between the anode electrode and cathode electrode, and a gas diffusion layer adjacent to one of the cathode electrode or the anode electrode, the gas diffusion layer including at least one microporous layer having an ink with carbon powder and an ionomer.

A method for manufacturing a membrane electrode assembly, includes arranging a polymer electrolyte membrane between an anode electrode and a cathode electrode, and arranging a gas diffusion layer adjacent to the cathode electrode, the gas diffusion layer including at least one microporous layer having a carbon support and an ionomer.

In other features, the method further includes arranging a porous transport layer adjacent to the anode electrode.

In other features, the method further includes coating the at least one microporous layer on a macroporous layer of the gas diffusion layer without a sintering step.

In other features, the at least one microporous layer includes an ink with the carbon support, the ionomer, and at least one solvent, and the method further includes drying the at least one microporous layer at a temperature from 80 degrees Celsius to 220 degrees Celsius to remove the at least one solvent.

In other features, the at least one microporous layer is a single layer.

In other features, the at least one microporous layer includes an ink with the carbon support, the ionomer, and at least one solvent, the cathode electrode or the anode electrode includes at least one electrode ink with a catalyst, an ionomer and at least one solvent, and the method further includes coating both the at least one microporous layer and the cathode electrode or the anode electrode simultaneously.

In other features, the method further includes drying the at least one microporous layer and the cathode electrode or the anode electrode simultaneously at a temperature from 80 degrees Celsius to 220 degrees Celsius to remove the at least one solvent in the ink of the one microporous layer and the least one solvent of the electrode ink.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example polymer electrolyte membrane (PEM) electrolyzer according to the present disclosure;

FIG. 2 is a functional block diagram of an example PEM fuel cell according to the present disclosure;

FIG. 3 is a functional block diagram of an example membrane electrode assembly (MEA) with a microporous layer having a carbon support and an ionomer for a PEM electrolyzer, according to the present disclosure;

FIG. 4 is a functional block diagram of an example MEA with a microporous layer having a carbon support and an ionomer for a PEM fuel cell, according to the present disclosure;

FIG. 5 is a functional block diagram of an example MEA with multiple microporous layers each having a carbon support and an ionomer for a PEM electrolyzer, according to the present disclosure; and

FIGS. 6-7 are flowcharts of example methods for manufacturing a MEA, according to the present disclosure.

In the drawings, reference numbers may be reused to identify similar and/or identical elements.

### DETAILED DESCRIPTION

Polymer electrolyte membrane (PEM) cells may be used to produce electrical power or hydrogen. A PEM fuel cell is an electrochemical device that uses hydrogen as fuel and produces electrical power (electricity), and a PEM electrolyzer is an electrochemical device that uses water as fuel and produces hydrogen when electrical energy is applied. Each PEM cell includes a membrane electrode assembly (MEA) consisting of an anode electrode, a cathode electrode, a PEM therebetween, and a gas diffusion layer with a microporous layer coated thereon. Conventionally, the microporous layer consists of a complex ink made of carbon powder and a mix of binders, surfactants, and thickeners. The conventional microporous layer is done in a two-step process, wherein the complex ink is first coated on a carbon paper substrate of the gas diffusion layer and dried at 80-220 degree Celsius. To bind the fluoropolymer binders to the carbon powder and create a mass of material, a second sintering step at temperatures of 300 degrees Celsius or above is required after the microporous layer is coated on the gas diffusion layer and before the MEA is assembled. This sintering process creates an additional step and adds complexity and cost to the PEM cell membrane electrode assembly (MEA) manufacturing process.

The electrochemical cells according to the present disclosure utilize a gas diffusion layer with at least one microporous layer having a carbon support and an ionomer (e.g., a carbon-ionomer microporous layer). In such examples, the microporous layer is formed without conventional fluoropolymer binders, such as poly tetrafluoroethylene (PTFE), fluorinated ethylene propylene (FEP), etc. As a result, the microporous layer may be employed with PEM cells without the need for a sintering step. As such, the manufacturability of catalyst coated diffusion media (CCDM) and by extension PEM cell MEAs is greatly simplified as compared to traditional CCDMs and PEM cell MEAs having microporous layers formed with fluoropolymer binders and that require sintering. Additionally, PEM cells with carbon-ionomer microporous layers provide comparable performance results to that of conventional PEM cell MEAs with microporous layers formed with fluoropolymer binders, and the surface quality of the carbon-ionomer microporous layers is comparable to that of conventional microporous layers formed with fluoropolymer binders. Thus, using the carbon-ionomer microporous layers with PEM cells assists in simplifying the manufacturing process without compromising surface quality and PEM cell performance.

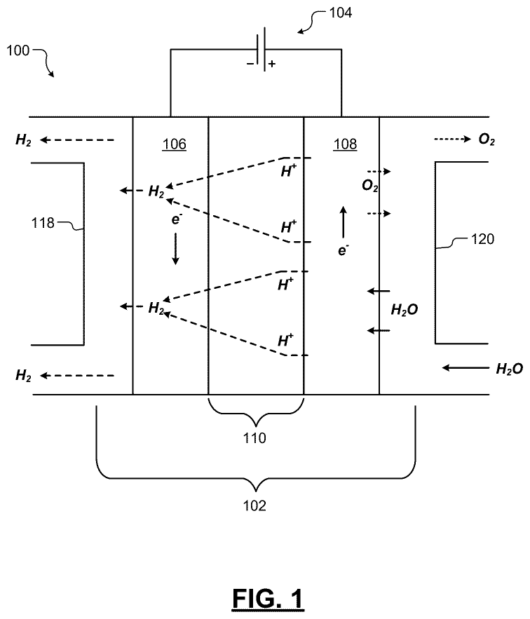

Referring now to FIG. 1, a block diagram of an example system 100 for PEM applications is presented. As shown in FIG. 1, the system 100 generally includes a water electrolysis cell 102 (e.g., sometimes referred to as a PEM electrolyzer) and a power source 104. The water electrolysis cell 102 (e.g., an electrochemical cell) includes a cathode electrode 106, an anode electrode 108, and a PEM 110 arranged between the anode electrode 108 and the cathode electrode 106. Additionally, the water electrolysis cell 102 includes a gas diffusion layer 118 adjacent to the cathode electrode 106, and a porous transport layer 120 adjacent to the anode electrode 108. While not shown in FIG. 1, the gas diffusion layer 118 includes at least one microporous layer that helps improve the cell's performance by managing fluid flow (e.g., water (H₂O), molecular hydrogen (H₂), and molecular oxygen (O₂)).

In the example of FIG. 1, the water electrolysis cell 102 may be use water as fuel to produce hydrogen. For example, the water electrolysis cell 102 receives water (H₂O), as shown in FIG. 1. The water (H₂O) passes through the porous transport layer 120, and is split into protons (H+) and oxygen when external electricity (e−) is applied at the anode electrode 108 by the power source 104. The protons (H+) then traverse through the PEM 110 and get reduced at the cathode electrode 106 to form molecular hydrogen (H₂). The molecular hydrogen (H₂) then passes through the gas diffusion layer 118, as shown in FIG. 1. If desired, the molecular hydrogen (H₂) may be stored in one or more containers for later use, such as in vehicle applications or non-vehicle applications.

For instance, a reduction reaction takes place at the cathode electrode 106 (which is negatively charged). Electrons (e⁻) from the cathode electrode 106 combine with hydrogen cations (H⁺) to form molecular hydrogen (H₂). At the anode electrode 108 (which is positively charged), an oxidation reaction occurs which generates molecular oxygen (O₂) and supplies electrons (e⁻) to the anode electrode 108 to complete the circuit. The two half-reactions (e.g., reduction and oxidation) are coupled to form a balanced system. For example, the half-reactions may include:
Cathode (reduction): 2H⁺(aq)+2e⁻→H₂(g); and
Anode (oxidation): H₂O(l)→½O₂ (g)+2 H⁺(aq)+2e⁻.
Overall: 2H₂O(l)→2H₂(g)+O₂(g)

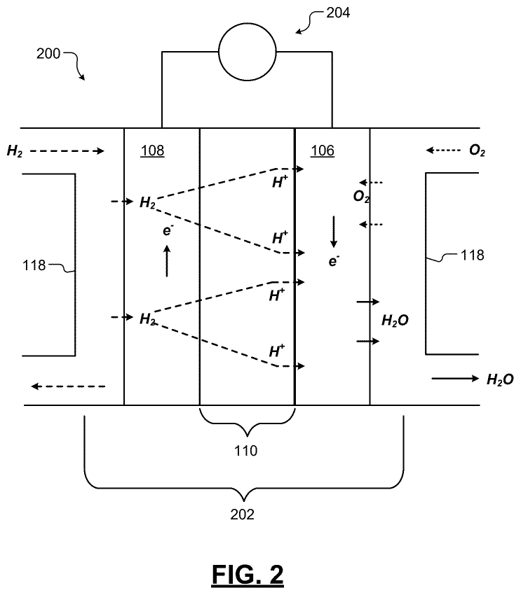

FIG. 2 is a block diagram of another example system 200 for PEM applications. The system 200 of FIG. 2 is similar to the system 100 of FIG. 1 but includes a PEM fuel cell 202 instead of the water electrolysis cell 102. As such, the PEM fuel cell 202 uses hydrogen as fuel to produce electrical power (electricity). As shown in FIG. 2, the system 200 generally includes the PEM fuel cell 202 (e.g., an electrochemical cell) and a load 204. In various embodiments, the PEM fuel cell 202 may be employed in a vehicle as a power generation device, in which the produced power is used to drive electric propulsion or another suitable load. In other examples, the PEM fuel cell 202 may be employed in non-vehicle applications if desired.

In the example of FIG. 2, the PEM fuel cell 202 includes the cathode electrode 106, the anode electrode 108, and the PEM 110 of FIG. 1. In this example, the PEM 110 may be a polymer electrolyte membrane. Additionally, the PEM fuel cell 202 includes gas diffusion layers 118 adjacent to the cathode electrode 106 and the anode electrode 108. While not shown in FIG. 2, the gas diffusion layers 118 each include at least one microporous layer that helps improve the cell's performance by managing fluid flow.

In this example, the PEM fuel cell 202 receives molecular hydrogen (H₂) and molecular oxygen (O₂) (usually from air), as shown in FIG. 2. The molecular hydrogen (H₂) is split into protons (H+) and electrons (e−), with the electrons (e−) flowing through the anode electrode 108 to an external circuit including the load 204 to provide electrical power for the load 204. The protons (H+) traverse through the PEM 110 to combine with the molecular oxygen (O₂) to produce water (H₂O).

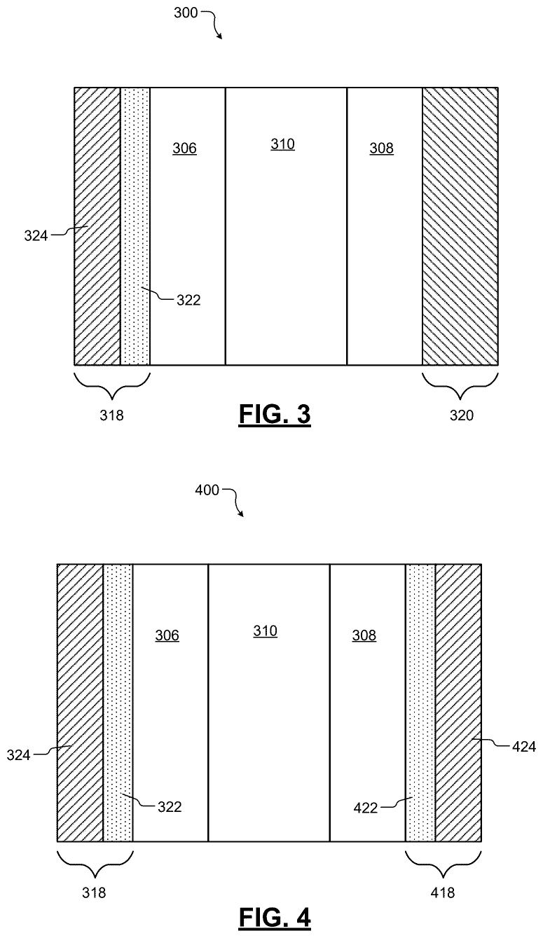

FIG. 3 depicts an example MEA 300 for an electrochemical cell employable as the water electrolysis cell 102 of FIG. 1 or another suitable application. As shown in FIG. 3, the MEA 300 includes a cathode electrode 306, an anode electrode 308, a PEM 310 arranged between the anode electrode 308 and the cathode electrode 306, a gas diffusion layer 318 arranged adjacent to the cathode electrode 306, and a porous transport layer 320 arranged adjacent to the anode electrode 308. For example, and as shown in FIG. 3, the PEM 310 may be arranged between inner surfaces of the cathode electrode 306 and the anode electrode 308, the gas diffusion layer 318 may be arranged on an outer surface of the cathode electrode 306, and the porous transport layer 320 may be arranged on an outer surface of the anode electrode 308.

As shown in FIG. 3, the gas diffusion layer 318 includes a microporous layer 322 that manages fluid flow (e.g., water (H₂O), molecular hydrogen (H₂), and molecular oxygen (O₂)). For example, the microporous layer 322 may be a thin layer with small pores to enable fluid flow therethrough.

In the example of FIG. 3, the microporous layer 322 has a carbon support and an ionomer. In such examples, a ratio of the ionomer to the carbon support (e.g., a weight percent of ionomer/a weight percent of carbon support) in the microporous layer 322 is 0.2 to 1.6. Importantly, the microporous layer 322 includes no hydrophobic binders, such as fluoropolymer binders, surfactants, thickeners, etc. As such, the microporous layer 322 may be employed without the need for a sintering step.

Additionally, in FIG. 3, the gas diffusion layer 318 further includes a macroporous layer 324 arranged adjacent to the microporous layer 322. In FIG. 3, the microporous layer 322 is arranged between the cathode electrode 306 and macroporous layer 324. In some examples, the microporous layer 322 may be coated on the macroporous layer 324. In various embodiments, the macroporous layer 324 may be carbon paper or another suitable layer having a greater porosity (e.g., larger pores) than the microporous layer 322. The macroporous layer 324 is more porous and more rigid to provide the structural support for the MEA 300. The microporous layer 322 or the carbon paper is commonly made from carbon fibers, bonded together by resin and carbonized at high temperature to enable higher electrical and thermal conductivity. The porous transport layer 320 facing the anode electrode 308 is also very porous and is largely rigid. Porous transport layer is typically made from sintered titanium powders and titanium fibers and combination thereof

In various embodiments, the ionomer of the microporous layer 322 may be any suitable type of ionomer. For example, the ionomer may be a fluorinated ionomer, such as perfluorosulfonic acid (e.g., Nafion™, etc.). In other examples, the ionomer of the microporous layer 322 may be a non-fluorinated ionomer, such as hydrocarbon ionomer (e.g., Pemion™, etc.). The equivalent weight (EW) of the ionomer can vary from 500 EW to 1500 EW. Higher EW of 800 or above is preferred due to reduced swelling and hence maintain porosity.

Additionally, the carbon support of the microporous layer 322 may be any suitable carbon component to achieve desired porosity of the microporous layer 322. For example, the carbon support may include carbon powder (e.g., DENKA BLACK, etc.), carbon flake, carbon fiber (e.g., vapor grown carbon fiber (VGCF), etc.), or a combination thereof. In such examples, if carbon powder is employed, the carbon powder may have a particle size of 20 nm to 250 nm to achieve desired porosity of the microporous layer 322.

In various embodiments, the microporous layer 322 may be formed on the gas diffusion layer 318, and more specifically the macroporous layer 324. For example, the microporous layer 322 may be coated on or otherwise applied to the macroporous layer 324. In such examples, the microporous layer 322 may be in the form of an ink with the carbon support (e.g., carbon powder, etc.), the ionomer, and one or more solvents (e.g., alcohol, water, etc.). Then, once the microporous layer 322 is coated on the macroporous layer 324, the microporous layer 322 may be heated to a desired temperature to dry the ink composition and remove the one or more solvents. For example, the microporous layer 322 may be dried at a temperature from 80 degrees Celsius to 220 degrees Celsius.

Additionally, in some examples, the microporous layer 322 and the cathode electrode 306 can be simultaneously formed to create a gas diffusion electrode. For example, the microporous layer 322 may be coated on or otherwise applied to the macroporous layer 324 as explained above. At the same time, the cathode electrode 306 may be coated on or otherwise applied to the microporous layer 322, and then hardened (if necessary) and the microporous layer 322 may be dried to form a gas diffusion electrode with the gas diffusion layer 318 and the cathode electrode 306. In certain embodiments, the carbon ionomer microporous layer ink and the cathode electrode ink are simultaneously coated as a multilayer in a single coating step to form gas diffusion electrode (GDE) or catalyst coated on diffusion media (CCDM). A dural slot die is typically employed for such multilayer coating. Such multilayer coating is enabled because the carbon ionomer microporous layer ink is compositionally compatible to the electrode ink.

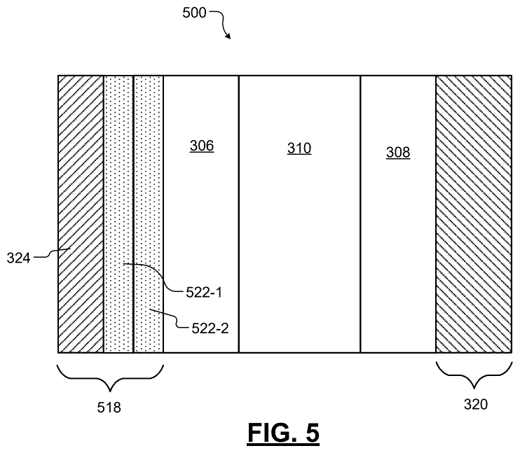

FIG. 4 depicts an example MEA 400 for an electrochemical cell employable as the PEM fuel cell 202 of FIG. 2 or another suitable application. The MEA 400 is similar to the MEA 300 of FIG. 3 but includes different components for providing fuel cell functionality. For example, and as shown in FIG. 4, the MEA 400 includes the cathode electrode 306, the anode electrode 308, the PEM 310, and the gas diffusion layer 318 with the microporous layer 322 and the macroporous layer 324 of FIG. 3. These components may include similar features, functions, and be formed in a similar manner as described above related to FIG. 3.

As shown in FIG. 4, the MEA 400 further includes another gas diffusion layer 418 arranged adjacent to the anode electrode 308. In some examples, the gas diffusion layer 418 may be similar to the gas diffusion layer 318 explained above. For example, the gas diffusion layer 418 may include a microporous layer 422 and a macroporous layer 424 similar to the microporous layer 322 and the macroporous layer 324 of FIG. 3. In such examples, the microporous layer 422 may have a carbon support and an ionomer, and the macroporous layer 424 may be carbon paper, as explained above. For instance, the microporous layer 422 may have the same or different type of carbon support and/or ionomer as the microporous layer 322, and/or the same or different ratio of the carbon support to the ionomer, as explained above. In other examples, the microporous layer 422 may have different components than the microporous layer 322 if desired. In either case, the microporous layer 422 may be employed without the need for a sintering step.

Additionally, the microporous layer 422 may be formed on the gas diffusion layer 418, and more specifically the macroporous layer 424 in a similar manner as explained above relative to FIG. 3. For example, in FIG. 4, the microporous layer 422 may be an ink with the carbon support, the ionomer, and one or more solvents that is coated on or otherwise applied to the macroporous layer 424. Then, the microporous layer 422 may be heated to a desired temperature (e.g., from 80 degrees Celsius to 220 degrees Celsius) to dry the ink composition and remove the one or more solvents.

Further, in some examples, the microporous layer 422 and the anode electrode 308 can be simultaneously formed to create a gas diffusion electrode. For example, the microporous layer 422 and the anode electrode 308 may be formed to create a gas diffusion electrode in a similar manner as explained above relative to the microporous layer 322 and the cathode electrode 306. For instance,

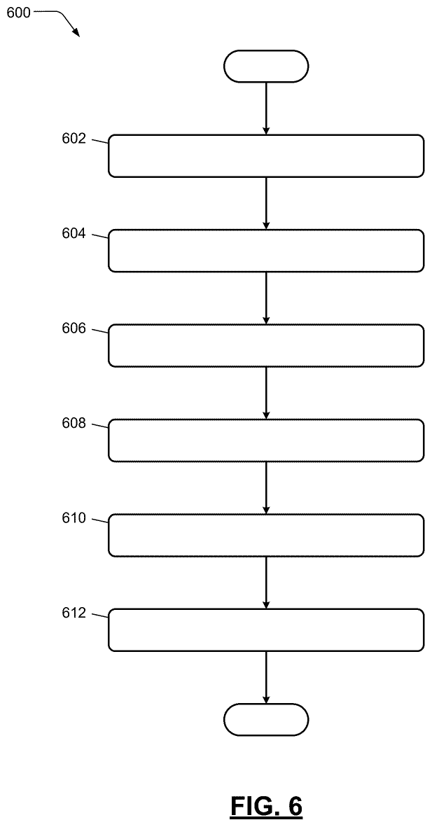

In various embodiments, the microporous layer 322, 422 of the gas diffusion layer 318, 418 may be a single layer as shown in FIGS. 3-4. In other examples, the gas diffusion layer 318, 418 of FIGS. 3-4 may include multiple microporous layers. For example, FIG. 5 depicts an example MEA 500 substantially similar to the MEA 300 of FIG. 3. In FIG. 5, the MEA 500 includes the cathode electrode 306, the anode electrode 308, the PEM 310, and the porous transport layer 320 of FIG. 3, along with a gas diffusion layer 518 having two microporous layers 522-1, 522-2 and the macroporous layer 324 of FIG. 3. While the MEA 500 of FIG. 5 is shown as including two microporous layers 522-1, 522-2, it should be appreciated that the MEA 500 may include more microporous layers if desired.

In various embodiments, any one of the MEAs herein may include other optional components. For example, any one of the MEAs may be gasketed when applied in an electrochemical cell and stack to support fluid flow (e.g., water (H₂O), molecular hydrogen (H₂), and molecular oxygen (O₂)) and provide a seal to restrict flows to their respective compartments. For instance, in a catalyst coated membrane (CCM) approach where the anode and cathode electrodes are applied to the membrane, a gasket can be applied between each electrode and a microporous layer. In other embodiments where an electrode is coated on a microporous layer, a gasket is applied between the electrode (e.g., the cathode electrode 306) and a membrane (e.g., the membrane 310).

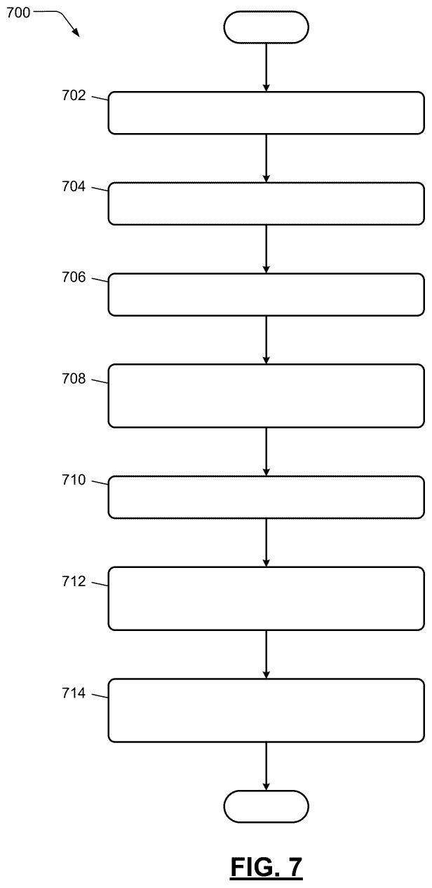

FIG. 6 illustrates an example method 600 for manufacturing an MEA, such as the MEA 300 of FIG. 3, the MEA 400 of FIG. 4 or another suitable the electrochemical cell. In the example of FIG. 6, a CCM is provided and gas diffusion layers with carbon ionomer microporous layers are placed adjacent to electrodes, as further explained below.

As shown in FIG. 6, the method 600 begins at 602 by arranging a PEM between cathode and anode electrodes. The method 600 then proceeds to 604. At 604, a microporous layer is formed. In such examples, the microporous layer may be in the form of an ink with a carbon support (e.g., carbon powder, etc.), an ionomer, and one or more solvents (e.g., alcohol, water, etc.), as explained above. The method 600 then proceeds to 606, where the microporous layer is coated on a macroporous layer to form a gas diffusion layer. Then, at 608, the microporous layer is dried at a temperature (e.g., from 80 degrees Celsius to 220 degrees Celsius) to remove the one or more solvents in the microporous layer. In the examples herein, the microporous layer is coated on the macroporous layer and dried without a sintering step as binding polymer binders (e.g., fluoropolymer binders) into a mass of material is not needed because the microporous layer does not include such binders. The method 600 then proceeds to 610.

At 610, the gas diffusion layer is arranged adjacent to the cathode electrode. In some examples, the drying step of 608 may occur after the gas diffusion layer is arranged adjacent to the cathode electrode in 608 if desired. The method 600 then proceeds to 612.

At 612, another layer is arranged adjacent to the anode electrode depending on, for example, the type of electrochemical cell being manufacture. For example, at 612, another gas diffusion layer with a microporous layer and a macroporous layer may be arranged adjacent to the anode electrode. Alternatively, a porous transport layer may be arranged adjacent to the anode electrode. The method 600 then ends as shown in FIG. 6.

FIG. 7 illustrates another example method 700 for manufacturing an MEA, such as the MEA 300 of FIG. 3, the MEA 400 of FIG. 4 or another suitable the electrochemical cell. As shown in FIG. 7, the method 700 begins at 702 by forming microporous layer composed of ink with carbon powder, ionomer and solvent. The method 700 then proceeds to 704.

At 704, the microporous layer is coated on a microporous layer to form a gas diffusion layer. The method 700 then proceeds to 706, where the microporous layer is dried at a temperature to remove the solvent. Then, at 708, the method 700 includes coating electrode ink (e.g., for a cathode electrode or an anode electrode) on the carbon ionomer microporous layer to form a gas diffusion electrode. In such examples, the electrode ink (for forming the cathode electrode or the anode electrode) includes a catalyst, an ionomer and at least one solvent. At 710, the electrode layer (or the coated ink) is dried at a temperature to remove solvent in the ink. In some examples, the steps 704, 706, 708, 710 may be performed separately as generally shown in FIG. 7. In other examples, steps 704, 708 and steps 706, 710 may be combined to coat the carbon ionomer microporous layer and electrode layer simultaneously and then dry the layers simultaneously.

The method 700 then proceeds to 712, where the gas diffusion electrode with the carbon ionomer microporous layer (of 704) is arranged on (e.g., positioned adjacent to) a PEM. Then, at 714, the method 700 includes arranging another (second) gas diffusion electrode with a carbon ionomer microporous layer or electrode with a porous transport layer. The method 700 then ends as shown in FIG. 7.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is

1. A membrane electrode assembly comprising:
a cathode electrode;
an anode electrode;
a polymer electrolyte membrane between the anode electrode and the cathode electrode; and
a gas diffusion layer adjacent to the cathode electrode, the gas diffusion layer including at least one microporous layer having a carbon support and an ionomer.

2. The membrane electrode assembly of claim 1, wherein:
the gas diffusion layer is a first gas diffusion layer; and
the membrane electrode assembly further includes a second gas diffusion layer adjacent to the anode electrode.

3. The membrane electrode assembly of claim 1, further comprising a porous transport layer adjacent to the anode electrode.

4. The membrane electrode assembly of claim 1, wherein the ionomer of the microporous layer is a fluorinated ionomer.

5. The membrane electrode assembly of claim 1, wherein the ionomer of the microporous layer is a non-fluorinated ionomer.

6. The membrane electrode assembly of claim 1, wherein the carbon support includes carbon powder, carbon flake, carbon fiber, or a combination thereof.

7. The membrane electrode assembly of claim 6, wherein the carbon powder has a particle size of 20 nm to 250 nm.

8. The membrane electrode assembly of claim 1, wherein a ratio of the ionomer to the carbon support is 0.2 to 1.6.

9. The membrane electrode assembly of claim 1, wherein the at least one microporous layer of the gas diffusion layer is a single layer.

10. The membrane electrode assembly of claim 1, wherein the at least one microporous layer of the gas diffusion layer includes two or more layers.

11. The membrane electrode assembly of claim 1, wherein the at least one microporous layer of the gas diffusion layer includes no hydrophobic binder.

12. An electrochemical electrolysis cell comprising the membrane electrode assembly of claim 3.

13. An electrochemical fuel cell comprising:
a membrane electrode assembly comprising:
a cathode electrode;
an anode electrode;
a polymer electrolyte membrane between the anode electrode and cathode electrode; and
a gas diffusion layer adjacent to one of the cathode electrode or the anode electrode, the gas diffusion layer including at least one microporous layer having an ink with carbon powder and an ionomer.

14. A method for manufacturing a membrane electrode assembly, the method comprising:
arranging a polymer electrolyte membrane between an anode electrode and a cathode electrode; and
arranging a gas diffusion layer adjacent to the cathode electrode, the gas diffusion layer including at least one microporous layer having a carbon support and an ionomer.

15. The method of claim 14, further comprising arranging a porous transport layer adjacent to the anode electrode.

16. The method of claim 14, further comprising coating the at least one microporous layer on a macroporous layer of the gas diffusion layer without a sintering step.

17. The method of claim 16, wherein:
the at least one microporous layer includes an ink with the carbon support, the ionomer, and at least one solvent; and
the method further includes drying the at least one microporous layer at a temperature from 80 degrees Celsius to 220 degrees Celsius to remove the at least one solvent.

18. The method of claim 16, wherein the at least one microporous layer is a single layer.

19. The method of claim 17, wherein:
the at least one microporous layer includes an ink with the carbon support, the ionomer, and at least one solvent;
the cathode electrode or the anode electrode includes at least one electrode ink with a catalyst, an ionomer and at least one solvent; and
the method further includes coating both the at least one microporous layer and the cathode electrode or the anode electrode simultaneously.

20. The method of claim 19, further comprising drying the at least one microporous layer and the cathode electrode or the anode electrode simultaneously at a temperature from 80 degrees Celsius to 220 degrees Celsius to remove the at least one solvent in the ink of the one microporous layer and the least one solvent of the electrode ink.
